(19) United States
(12) Patent Application Publication
(10) Pub. No.: US 2007/0224883 A1
(43) Pub. Date: Sep. 27, 2007

(54) Electrical connector

(75) Inventors: Yat To Chan, Tauyuan Hsien (TW); Tsung Sheng Fu, Tauyuan Hsien (TW)

Correspondence Address: CHARLES E. BAXLEY, ESQ., 90 JOHN STREET, THIRD FLOOR, NEW YORK, NY, 10038, US

(73) Assignee: Joymax Electronics Co., Ltd.

(21) Appl. No.: 11/387,132

(22) Filed: Mar. 21, 2006

(51) Int. Cl. H01R 13/648

(52) U.S. Cl. 439/607

(57) ABSTRACT

An electrical connector includes an insulating base member having a chamber and a bore formed in a protrusion, a conductor rod having one limb engaged through the bore of the protrusion and the other limb engaged in the chamber of the base member for acting as a central electrode of the electrical connector, a conductor sleeve is engaged onto the protrusion and a conductor casing is engaged onto the base member and electrically connected to the sleeve for acting as a case electrode of the electrical connector. The casing may be easily and quickly anchored to the base member with one or more anchoring members or latches, and the casing may be easily and quickly secured to the sleeve with a bar or a tongue.

### BACKGROUND OF THE INVENTION

1. Field of the Invention

The present invention relates to an electrical connector, and more particularly to an electrical connector having a construction for being easily manufactured and assembled without complicated manufacturing processes.

2. Description of the Prior Art

Typical electrical connectors comprise a pin or conductor rod to be engaged in a receptacle and stably supported in the receptacle with an insulating member for forming or acting as a central electrode of the electrical connector, and an outer sleeve required to be engaged onto the receptacle and disposed or arranged around the conductor rod, and spaced from the conductor rod with one or more further insulating member for forming or acting as a case electrode of the electrical connector.

For example, U.S. Pat. No. 4,047,786 to Gietzen discloses one of the typical electrical connectors comprising a rod engaged in a sleeve and supported in an insulating receptacle and spaced from each other with one or more insulating members, and two pins also engaged in the insulating receptacle and required to be electrically coupled to the rod and the sleeve with two electrical conductors respectively for allowing the rod and the sleeve to be formed or acted as a central electrode and a case electrode of the electrical connector respectively.

However, it will be difficult to form or to machine one or more L-shaped holes or chambers in the insulating receptacle, and it will also be difficult to engage the rod and the sleeve and the insulating members and the pins and the electrical conductors into the insulating receptacle, and it will further be difficult to electrically couple the pins to the rod and the sleeve with the electrical conductors respectively, such that a number of complicated manufacturing and machining processes and a number of assembling processes are required to make the typical electrical connectors, and the manufacturing cost of the typical electrical connectors will be greatly increased.

The present invention has arisen to mitigate and/or obviate the afore-described disadvantages of the conventional electrical connectors.

### SUMMARY OF THE INVENTION

The primary objective of the present invention is to provide an electrical connector including a construction for being easily manufactured and assembled without complicated manufacturing processes, and for greatly reducing the manufacturing cost of the electrical connector.

In accordance with one aspect of the invention, there is provided an electrical connector comprising an insulating base member including a chamber formed therein, and including a protrusion extended therefrom, and including a bore formed through the protrusion and communicating with the chamber of the base member, a conductor rod including a first limb and a second limb bent relative to each other, the first limb being engaged through the bore of the protrusion or of the base member and the second limb being engaged in the chamber of the base member, the conductor rod being acted as a central electrode of the electrical connector, a conductor sleeve including a bore formed therein for engaging onto and for receiving the protrusion of the base member and for attaching the conductor sleeve onto the protrusion of the base member, and a conductor casing including a space formed therein for engaging onto and for receiving the base member and for attaching the conductor casing onto the base member, the conductor casing is electrically connected to the conductor sleeve for being acted as a case electrode of the electrical connector. The conductor rod and the conductor casing and the conductor sleeve may be easily and quickly secured or assembled onto the base member.

The base member includes at least one anchoring member for engaging with the conductor rod and for anchoring the conductor rod to the base member. The anchoring member is preferably extended into the chamber of the base member.

The base member includes at least one latch for engaging with the conductor rod and for anchoring the conductor rod to the base member. The latch is preferably extended into the chamber of the base member. The base member includes a bottom opening formed therein, and the second limb of the conductor rod being extended through the bottom opening of the base member.

The base member includes at least one recess formed therein, and the casing includes at least one catch extended therefrom for engaging with the recess of the base member and for anchoring and securing the casing to the base member. The base member may also include at least one depression formed therein, and the casing includes at least one key extended therefrom for engaging with the depression of the base member and for anchoring and securing the casing to the base member.

The sleeve includes a slot formed therein, and the casing includes a bar extended therefrom for engaging with the slot of the sleeve and for anchoring and securing the casing to the sleeve and for electrically connecting the casing to the sleeve. The sleeve includes an orifice formed therein and communicating with the bore and the slot of the sleeve, and the casing includes a tongue extended from the bar for engaging with the orifice of the sleeve, and for further anchoring and securing the casing to the sleeve.

The casing includes a projection extended therefrom for engaging with the sleeve and for anchoring and securing the casing to the sleeve. The base member includes a groove formed therein and partially formed into the protrusion of the base member, and the tongue of the casing is engaged into the groove of the base member for further anchoring and securing the casing to the sleeve.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an electrical connector in accordance with the present invention, as seen from the front portion of the electrical connector;

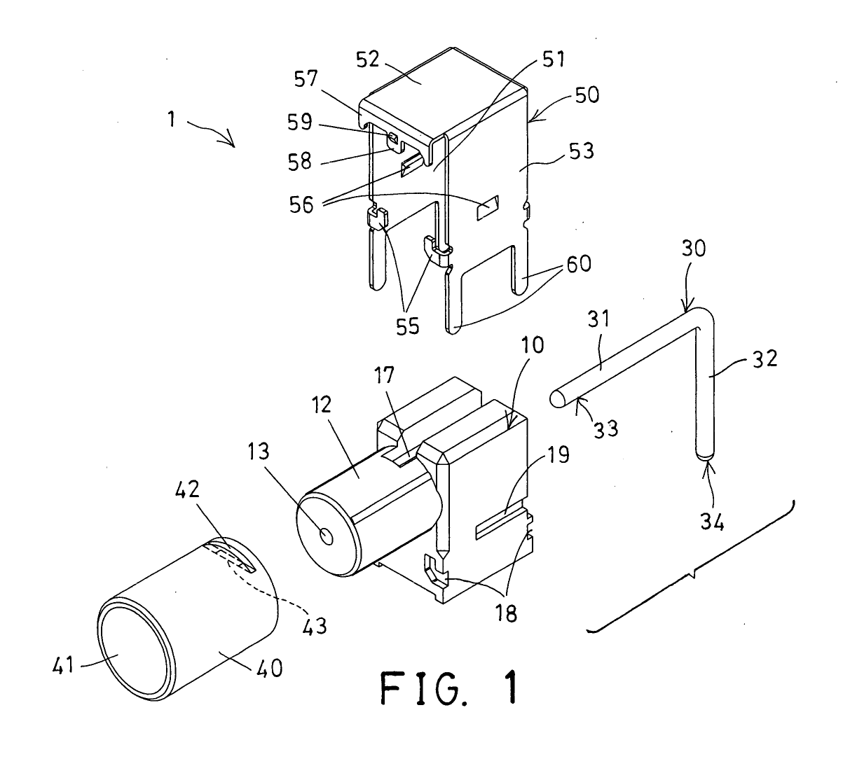

FIG. 2 is another exploded view of the electrical connector as seen from the rear portion of the electrical connector;

FIG. 3 is a front perspective view of the electrical connector; and

FIG. 4 is a cross sectional view of the electrical connector, taken along lines 4-4 of FIG. 3, illustrating the inner structure of the electrical connector.

### DETAILED DESCRIPTION OF THE PREFERRED EMBODIMENT

Referring to the drawings, an electrical connector 1 in accordance with the present invention comprises a body or base member 10 made of such as plastic materials or other electrically insulating members, and the base member 10 may be easily and quickly made or formed with molding or mold-injection processes. The base member 10 preferably includes a spatial or substantially parallelepiped structure and includes a chamber 11 formed therein, such as formed in the rear portion thereof, and includes a protrusion 12, such as a cylindrical protrusion 12 extended forwardly therefrom, and a bore 13 formed through the protrusion 12 and communicating with the chamber 11 of the base member 10.

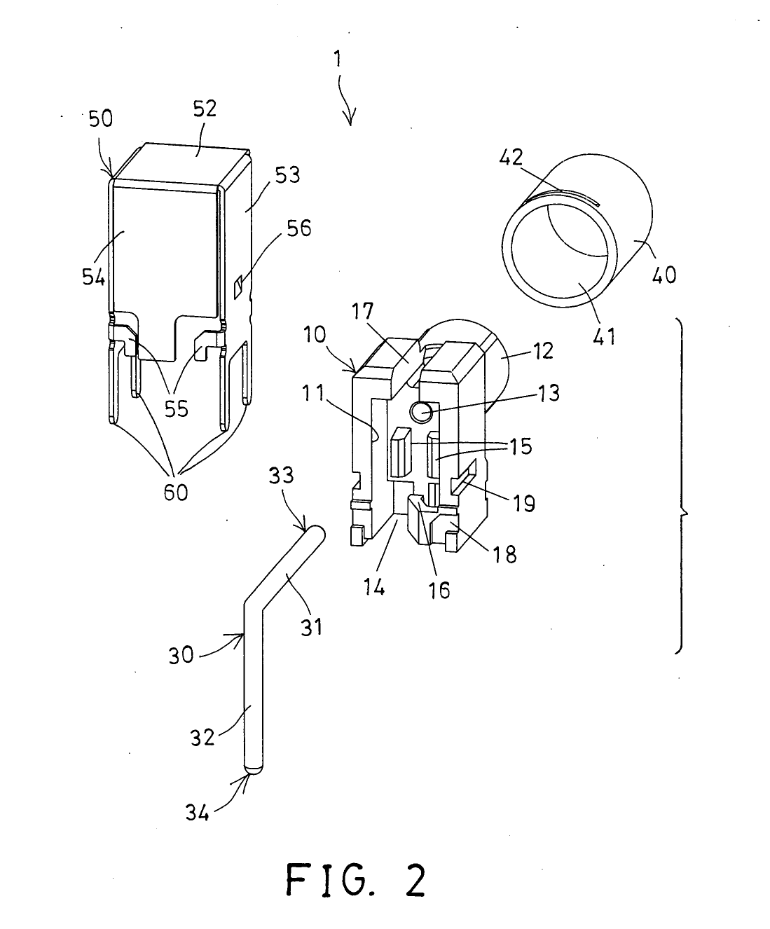

An L-shaped conductor rod 30 includes two segments or limbs 31, 32 that are bent relative to each other or perpendicular to each other, in which the first or front limb 31 may be engaged through the bore 13 of the protrusion 12 or of the base member 10 and may include a front or free end 33 extended forwardly and outwardly through or beyond the protrusion 12 of the base member 10, and the other or second or rear limb 32 may be engaged through or in the chamber 11 of the base member 10, and may include a lower or free end 34 extended downwardly and outwardly through or beyond the base member 10, such as extended out through a bottom opening 14 (FIG. 2) of the base member 10.

The conductor rod 30 may be formed or acted as a central electrode of the electrical connector 1 and suitably shielded and insulated by the insulating base member 10. It is preferable that the base member 10 includes one or more, such as two anchoring members 15 extended rearwardly and extended into the chamber 11 of the base member 10 for engaging with the conductor rod 30 and for stably anchoring and positioning the conductor rod 30 to the base member 10. The base member 10 may further include one or more latches 16, such as spring latches 16 extended therefrom and also extended into the chamber 11 of the base member 10 for further engaging with the conductor rod 30 and for further stably latching and positioning or securing the conductor rod 30 to the base member 10.

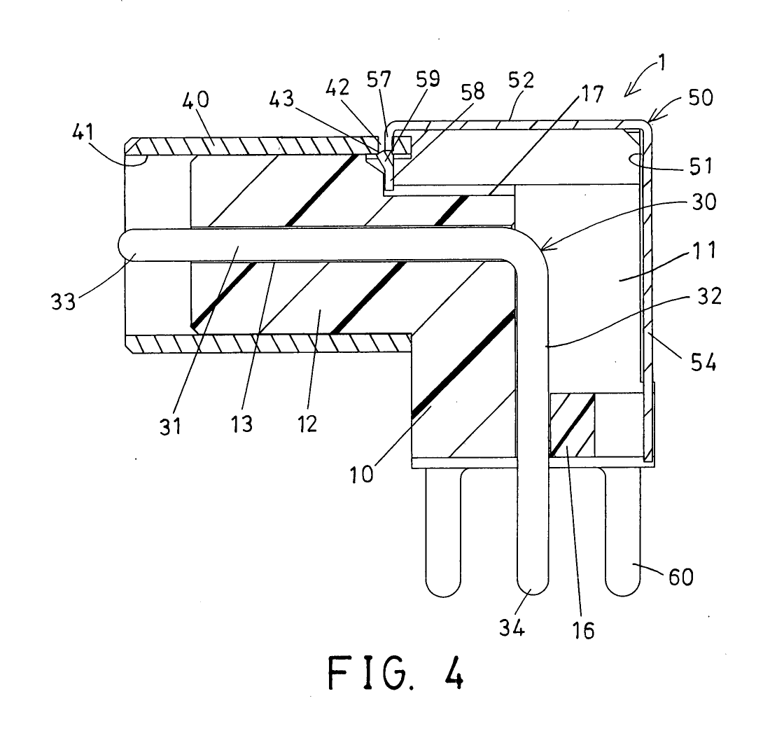

The base member 10 includes a groove 17 formed in the upper portion thereof and partially formed into the protrusion 12 of the base member 10 and communicating with the chamber 11 of the base member 10. A conductor sleeve 40 includes a cylindrical structure corresponding to that of the protrusion 12 and includes a bore 41 formed therein for engaging onto or for receiving the protrusion 12 of the base member 10, and thus for attaching the conductor sleeve 40 onto the protrusion 12 of the base member 10. The sleeve 40 includes a lateral cut or slot 42 formed therein and located closer to the base member 10, and includes an orifice 43 formed therein and communicating with the bore 41 and the slot 42 of the sleeve 40, and aligned with the groove 17 of the base member 10 (FIG. 4).

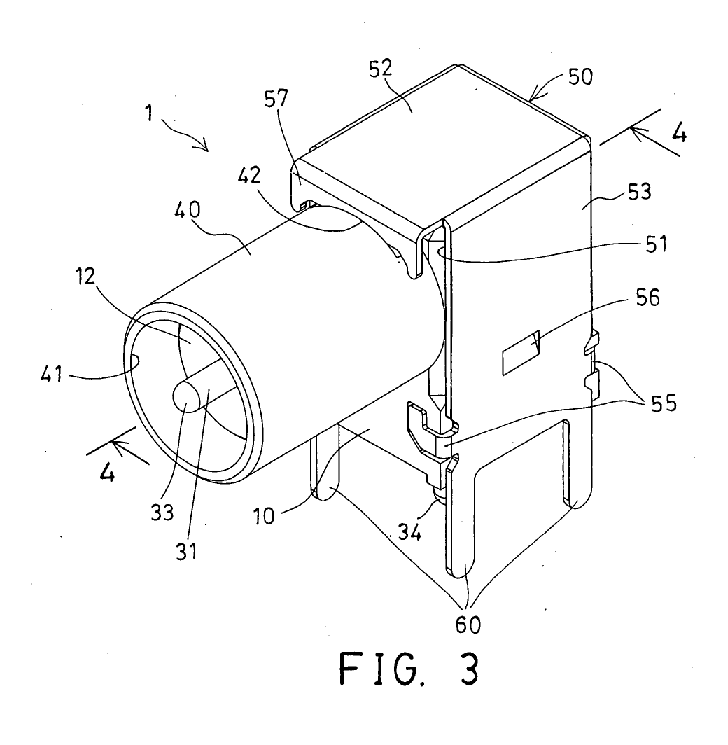

A conductor casing 50 is further provided for engaging onto the base member 10, and includes a space 51 formed therein and defined by an upper panel 52, two side panels 53 and a rear panel 54 for stably engaging onto the base member 10. The base member 10 includes one or more recesses 18 formed in the front portion and/or in the rear portion thereof, and one or more depressions 19 formed in either or both of the side portions thereof. The casing 50 includes one or more catches 55 extended from such as either or both of the side panels 53 and extended into the space 51 of the casing 50, for engaging with the recesses 18 of the base member 10 (FIG. 3) and for stably anchoring and securing the casing 50 to the base member 10. The casing 50 may further include one or more keys 56 extended into the space 51 of the casing 50, for engaging with the depressions 19 of the base member 10 and for further stably anchoring and securing the casing 50 to the base member 10.

The casing 50 further includes a flange or bar 57 extended downwardly from the front portion of the upper panel 52 for engaging into the slot 42 of the sleeve 40, and for anchoring and coupling or securing the casing 50 to the sleeve 40, and also for electrically connecting the casing 50 to the sleeve 40. The casing 50 further includes a tongue 58 extended downwardly from the bar 57 and engaged through the orifice 43 of the sleeve 40, and also engaged into the groove 17 of the base member 10 (FIG. 4) for further stably anchoring and securing the casing 50 to the base member 10 and to the sleeve 40.

The casing 50 further includes a projection 59 extended from the bar 57 or the tongue 58 for engaging with the sleeve 40 and for further stably anchoring and securing the casing 50 to the sleeve 40 and for preventing the casing 50 from being disengaged from the sleeve 40. The casing 50 and the sleeve 40 may thus be solidly secured together and electrically connected together for forming or acting as a case electrode of the electrical connector 1. The casing 50 and the sleeve 40 may be suitably spaced from the conductor rod 30 with the insulating base member 10 and the insulating protrusion 12 of the base member 10.

The casing 50 may further include one or more legs 60 extended downwardly from such as the side panels 53 and/or the rear panel 54 of the casing 50, and preferably arranged parallel to the other or second or rear limb 32 of the conductor rod 30, best shown in FIG. 4, for allowing the legs 60 of the casing 50 and the other or rear limb 32 of the conductor rod 30 to be easily engaged through various circuit boards (not shown) and to be electrically connected to various electrical facilities (not shown). The legs 60 of the casing 50 and the other or rear limb 32 of the conductor rod 30 may also be suitably spaced away from each other with the insulating base member 10 for preventing the legs 60 of the casing 50 and the other or rear limb 32 of the conductor rod 30 from being contacted with each other.

It is to be noted that the insulating base member 10 may be easily and quickly made or formed with molding or mold-injection processes, and the conductor rod 30 and the conductor sleeve 40 and the conductor casing 50 may also be easily and quickly made or formed with various machining processes separately. The conductor rod 30 may be easily and quickly engaged into the bore 13 of the protrusion 12 or of the base member 10 and the chamber 11 of the base member 10, and the conductor sleeve 40 may be easily and quickly engaged onto the protrusion 12 of the base member 10, and the conductor casing 50 may also be easily and quickly engaged onto the base member 10, and secured or latched to the conductor sleeve 40 with the bar 57 and/or the tongue 58 and/or the projection 59 for allowing the electrical connector 1 to be easily and quickly assembled.

Accordingly, the electrical connector in accordance with the present invention includes a construction for being easily manufactured and assembled without complicated manufacturing processes, and for greatly reducing the manufacturing cost of the electrical connector.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electrical connector comprising:
an insulating base member including a chamber formed therein, and including a protrusion extended therefrom, and including a bore formed through said protrusion and communicating with said chamber of said base member,
a conductor rod including a first limb and a second limb bent relative to each other, said first limb being engaged through said bore of said protrusion or of said base member and said second limb being engaged in said chamber of said base member, said conductor rod being acted as a central electrode of said electrical connector,
a conductor sleeve including a bore formed therein for engaging onto and for receiving said protrusion of said base member and for attaching said conductor sleeve onto said protrusion of said base member, and
a conductor casing including a space formed therein for engaging onto and for receiving said base member and for attaching said conductor casing onto said base member, said conductor casing being electrically connected to said conductor sleeve for being acted as a case electrode of said electrical connector.

2. The electrical connector as claimed in claim 1, wherein said base member includes at least one anchoring member for engaging with said conductor rod and for anchoring said conductor rod to said base member.

3. The electrical connector as claimed in claim 2, wherein said at least one anchoring member is extended into said chamber of said base member.

4. The electrical connector as claimed in claim 1, wherein said base member includes at least one latch for engaging with said conductor rod and for anchoring said conductor rod to said base member.

5. The electrical connector as claimed in claim 4, wherein said at least one latch is extended into said chamber of said base member.

6. The electrical connector as claimed in claim 1, wherein said base member includes a bottom opening formed therein, and said second limb of said conductor rod being extended through said bottom opening of said base member.

7. The electrical connector as claimed in claim 1, wherein said base member includes at least one recess formed therein, and said casing includes at least one catch extended therefrom for engaging with said at least one recess of said base member and for anchoring and securing said casing to said base member.

8. The electrical connector as claimed in claim 1, wherein said base member includes at least one depression formed therein, and said casing includes at least one key extended therefrom for engaging with said at least one depression of said base member and for anchoring and securing said casing to said base member.

9. The electrical connector as claimed in claim 1, wherein said sleeve includes a slot formed therein, and said casing includes a bar extended therefrom for engaging with said slot of said sleeve and for anchoring and securing said casing to said sleeve and for electrically connecting said casing to said sleeve.

10. The electrical connector as claimed in claim 9, wherein said sleeve includes an orifice formed therein and communicating with said bore and said slot of said sleeve, and said casing includes a tongue extended from said bar for engaging with said orifice of said sleeve, and for further anchoring and securing said casing to said sleeve.

11. The electrical connector as claimed in claim 10, wherein said casing includes a projection extended therefrom for engaging with said sleeve and for anchoring and securing said casing to said sleeve.

12. The electrical connector as claimed in claim 10, wherein said base member includes a groove formed therein and partially formed into said protrusion of said base member, and said tongue of said casing is engaged into said groove of said base member.
